(19) United States
(12) Patent Application Publication
(10) Pub. No.: US 2016/0100573 A1
(43) Pub. Date: Apr. 14, 2016

(54) QUATERNARY ORGANOSILICON SURFACTANTS, METHODS OF MAKING SAME AND APPLICATIONS CONTAINING THE SAME

(71) Applicant: Momentive Performance Materials Inc., Waterford, NY (US)

(72) Inventors: George A. Policello, Ossining, NY (US); Narayan Mukherjee, Sleepy Hollow, NY (US)

(21) Appl. No.: 14/524,430

(22) Filed: Oct. 27, 2014

Related U.S. Application Data
(60) Provisional application No. 62/062,281, filed on Oct. 10, 2014.

(51) Int. Cl. A01N 25/30; A01N 57/20; C07F 7/08

(52) U.S. Cl. CPC A01N 25/30; C07F 7/0854; A01N 57/20; C07F 7/0872

(57) ABSTRACT

There is provided herein a surfactant composition comprising quaternary organosilicons having the general formula (I)

AOₐR⁴_{b}(BO_{c}R¹¹_{d})ₑC.

There is also provided methods for making the quaternary organosilicons (I) and agricultural, coating, personal care and home care applications containing the quaternary organosilicons.

The present application claims priority to U.S. Provisional Patent Application 62/062,281, filed on Oct. 10, 2014, which is incorporated by reference herein in its entirety.

### FIELD OF THE INVENTION

The present invention is directed to surfactants, more specifically, quaternary organosilicon surfactants and their use in agricultural, coating, personal care and home care applications.

### BACKGROUND OF THE INVENTION

Surfactants have been used widely in many fields. In the use of surfactants, properties such as wetting, spreading, foaming, detergency, and the like are important in the various applications in which they are employed. Additionally, some surfactants have been shown to inhibit the uptake of various agrochemicals in various plant species. Thus, it would be advantageous to provide a surfactant that maintains desirable surfactant properties while also providing for increased uptake of agrochemicals in various plant species.

### BRIEF DESCRIPTION OF THE INVENTION

In accordance with the present invention, there has been unexpectedly discovered herein that the use of various quaternary organosilicon surfactants, which are essentially alkyl halide free and tallow amine ethoxylate free, provides for improved uptake of agrochemicals in various plant species. More specifically, it has been discovered herein that the quaternary organosilicon surfactants described herein have improved uptake of glyphosate into grasses over that of trisiloxane alkoxylates and carbosilane alkoxylates without the presence of a tallowamine ethoxylate.

A=R¹R²R³Si—;

B=−Si(R⁵)(R⁶)−;

C=R⁷R⁸R⁹Si—;

subscripts a, b, e, d and e are 0 or 1 and subject to the following relationships: a+b=1 and when e=1, c+d=1;

R¹, R², R³, R⁵, R⁷, R⁸ are independently selected from the group consisting of monovalent hydrocarbon groups containing from 1 to 8 carbon atoms, more specifically from 1 to 6 carbon atoms and monovalent aryl and alkaryl hydrocarbon groups containing from 6 to 12 carbon atoms, or R¹⁰,

wherein R¹⁰ is selected from a group consisting of branched monovalent hydrocarbon groups containing from 3 to 6 carbon atoms, such as the non-limiting examples of isopropyl, t-butyl and t-amyl;

R⁴ and R¹¹ are independently selected from the group consisting of a divalent hydrocarbon group containing from 1 to 4 carbon atoms, more specifically from 1 to 3 carbon atoms;

R⁶ and R⁹ are selected from the group consisting of linear or branched monovalent hydrocarbon groups containing from 1 to 8 carbon atoms, more specifically from 1 to 4 carbon atoms, or R¹², provided R⁶ and R⁹ are different and one of R⁶ or R⁹ is R¹².

wherein R¹² is selected from R* or —R¹³R¹⁴N^{⊕}(R¹⁵)(R¹⁶)R¹⁷)X^{\grave{Y}},

wherein R* is

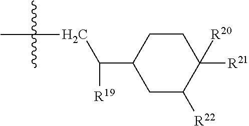

wherein R¹⁹ and R²⁰ are independently selected from H or Methyl,

R²¹ and R²² are different, and selected from OH or R²³;

R²³ is —N^{⊕})(R¹⁵)(R¹⁶)R¹⁷X^{\grave{Y}},

wherein R¹³ is a divalent hydrocarbon group containing from 3 to 12 carbon atoms, more specifically from 3 to 6 carbon atoms, and optionally substituted by one or more hydroxyl groups,

R¹⁴ is selected from the group consisting of —OCH₂CH(OH)CH₂— and an alkyleneoxide group of the general formula (II):

—[OC₂H₄]ₕ—[OC₃H₆]ᵢ—[OC₄H₈]ₖ—OCH₂CH(OH)CH₂— (II)

wherein subscripts h, i and k are zero or positive and satisfy the following relationships: 1≦h+i+k≦15, more specifically, 1≦h+i+k≦10, even more specifically h is from 0 to 8, i is from 0 to 5 and k is from 0 to 4,

R¹⁵ and R¹⁶ are independently selected from the group consisting of a monovalent hydrocarbon group containing from 1 to 2 carbon atoms,

R¹⁷ is selected from the group consisting of linear or branched hydrocarbon groups containing from 1 to 6 carbon atoms, which may each be optionally substituted with one or more hydroxyl groups, or an alkyleneoxide group of the general formula (III):

—[OC₂H₄]ₘ—[OC₃H₆]ₙ—[OC₄H₈]ₚ—R¹⁸ (III)

wherein subscripts m, n and p are zero or positive and satisfy the following relationships: 1≦m+n+p≦15, more specifically, 1≦m+n+p≦10, even more specifically m is from 0 to 8, n is from 0 to 5 and p is from 0 to 4,

R¹⁸ is selected from the group consisting of —OH and monovalent hydrocarbon groups containing from 1 to 4 carbon atoms; and

X^{\grave{Y}} is R³⁴, or a more biodegradable group R^{PE},

R³⁴ is selected from the group consisting of carboxylic acid anion moiety containing from 2 to 22 carbon atoms, more specifically from 2 to 12 carbon atoms, and has the general formula:

^{\grave{Y}}O—C(═O)—C(R³⁵)(R³⁶)(R³⁷)

wherein subscripts q, r and s are 0 or 1,

R³⁵ and R³⁶ are selected from H, OH, a hydrocarbon group of 1-3 carbon atoms or CH₂OH,

R³⁷ is selected from H, OH, a hydrocarbon group of 1-3 carbon atoms, CH₂OH or —(CH R³⁸)_{f}—CH₂R³⁹,

wherein

R³⁸ is H, OH, a hydrocarbon group of 1-3 carbon atoms or CH₂OH;

R³⁹ is selected for H or OH,

subscript f is 0 to 3.

R^{PE} is a polyester moiety derived from the esterification of the corresponding hydroxy carboxylic acid or a mixture of corresponding hydroxy carboxylic acids and carboxylic acids, wherein the hydroxy carboxylic acid(s) contain(s) from 2 to 8 carbon atoms, more specifically from 2 to 5 carbon atoms, and R^{PE} is of the general formula (Z):

^{\grave{Y}}O—C(═O)—CH_{(3-[q+r+s])}(R²⁴)_{q}(R²⁵)ᵣ(R²⁶)ₛ (Z)

subscripts q, r and s are 0 or 1,

where R²⁴, R²⁵, R²⁶ are independently selected from —OH, —CH₂OH, —(CH₂)ₘOR²⁷, —CH₃, —CH₂CH₃, —(CH₂)ₘO—C(═O) (CR³⁰R³¹)ₜCH₂OR³², or R²⁸,

where R²⁷ is —C(═O)—CH_{(3-[q+r+s])}(R²⁴)_{q}(R²⁵)ᵣ(R²⁶)ₛ

R²⁸ is —R²⁹OR²⁷, where R²⁹ is a divalent hydrocarbon radical of 2 to 6 carbon atoms,

R³⁰ and R³¹ are independently selected from H, —OH, —CH₂OH, —(CH₂)ₘO—R²⁷, —CH₃, —CH₂CH₃, or —(CH₂)ₘO—C(═O)—(CR³⁰R³¹)ₜCH₂OR³²,

R³² is independently selected from H, —CH₂OH, —CH₃, —CH₂CH₃, R²⁷, or [—C(═O)(CR³⁰R³¹)ₜCH₂O]_{w}—R³³,

R³³ is independently selected from H, —CH₂OH, —CH₃, or —CH₂CH₃

where,

subscript m is 0 to 3,

subscript t is 1 to 5,

subscript w is 1 to 5, and

the number of R^{PE} is between 1 and 10.

Non-limiting Illustrative examples of the biodegradable polyester modified hydroxy acids are given below (FIGS. 1and 2), where the ester linkage provides enhanced biodegradation properties relative to a traditional trisiloxane alkoxylate.

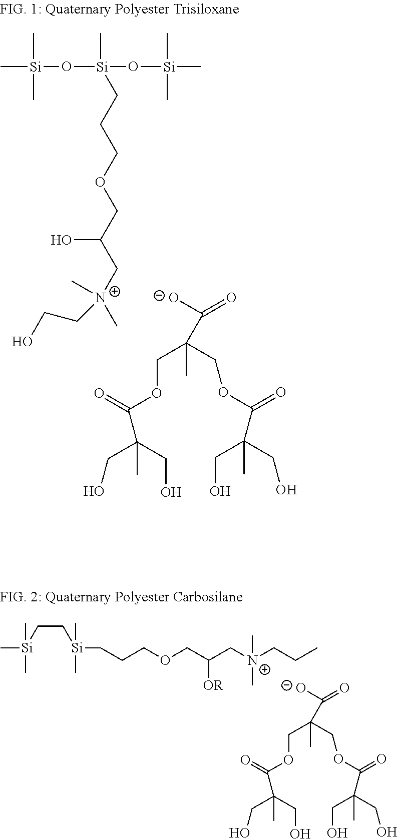

There are also provided herein methods of making the quaternary organosilicon having the general formula (I) described above.

Various other features, aspects and advantages of the present invention, will become more apparent with reference to the following description and appended claims.

### DETAILED DESCRIPTION OF THE INVENTION

In one embodiment herein the quaternary organosilicon has the general formula (I) wherein X^{\grave{Y}} is selected from the group consisting of anions of monocarboxylic acids, dicarboxylic acids, alpha-hydroxyl acids, beta-hydroxyl acids, dihydroxy acids and saturated and unsaturated fatty acids.

In one more specific embodiment herein, the quaternary organosilicon has the general formula (IV):

AR⁴C (IV)

wherein

A=R¹R²R³Si—; and

C=R⁷R⁸R⁹Si—;

wherein R¹, R², R³, R⁷ and R⁸ are methyl;

R⁴ is —CH₂CH₂—;

R⁹ is R¹²,

wherein R¹² is —R¹³R¹⁴N^{⊕}(R¹⁵)(R¹⁶)R¹⁷X^{\grave{Y}},

wherein R¹³ is —CH₂CH₂CH₂—;

R¹⁴ is —OCH₂CH(OH)CH₂—;

R¹⁵ and R¹⁶ are methyl;

R¹⁷ is —CH₂CH(OH)CH₂—OH; and

X^{\grave{Y}} is CH₃C(CH₂OH)₂COO—.

In another more specific embodiment herein, the quaternary organosilicon has the general formula (V):

AR⁴BOC (V)

wherein

A=R′R²R³Si—;

B=—Si(R⁵)(R⁶)—; and

C=R⁷R⁸R⁹Si—;

wherein R¹, R², R³, R⁵, R⁶, R⁷ and R⁸ are methyl;

R⁴ is —CH₂CH₂—;

R⁹ is R¹²;

wherein R¹² is —R¹³R¹⁴N^{⊕}(R¹⁵)(R¹⁶)R¹⁷X^{\grave{Y}},

wherein R¹³ is —CH₂CH₂CH₂—;

R¹⁴ is —OCH₂CH(OH)CH₂—;

R¹⁵ and R¹⁶ are methyl;

R¹⁷ is —CH₂CH₂CH₂OH; and

X^{\grave{Y}} is CH₃C(CH₂OH)₂COO—.

In yet another preferred embodiment herein, the quaternary organosilicon has the general formula (V-B):

AOBOC (V-B)

wherein

A=R′R²R³Si—;

B=—Si(R⁵)(R⁶)—; and

C=R⁷R⁸R⁹Si—;

wherein R¹, R², R³, R⁵, R⁷, R⁸ and R⁹ are methyl;

R⁶ is R¹²;

wherein R¹² is —R¹³R¹⁴N^{⊕}(R¹⁵)(R¹⁶)R¹⁷X^{\grave{Y}},

wherein R¹³ is —CH₂CH₂CH₂—;

R¹⁴ is —OCH₂CH(OH)CH₂—;

R¹⁵ and R¹⁶ are methyl;

R¹⁷ is —CH₂CH₂CH₂OH; and

X^{\grave{Y}} is CH₃C(CH₂OH)₂COO—.

There is also provided herein a method of making the quaternary organosilicon having the general formula (I) which method comprises:

(a) reacting a hydride intermediate with an olefinically-modified intermediate in the presence of a catalyst, such as a hydrosilylation catalyst, such as the non-limiting examples of precious metal catalysts such as those described herein; and wherein the olefinically-modified intermediate is a molecule containing one or more oxirane or oxetane groups and containing one or more terminal or pendant carbon-carbon bonds, and containing from 4-12 carbon atoms, such as the non-limiting examples of allyl oxiranes, olefinically modified epoxides, such as those of the general formula: CH₂═CH—(CH₂)_{y}O(CH₂)_{z}CH(O)CH₂, where subscripts y and z are from 1 to 10, or

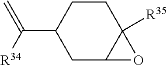

wherein R³⁴ and R³⁵ are independently selected from the group consisting of hydrogen or a methyl group, and where one non-limiting example of olefinically-modified intermediate is allyl glycidyl ether and where, in one embodiment, the hydride intermediate has the general formula (VI):

AOₐR⁴_{b}(B^{H}O_{c}R¹¹_{d})ₑC^{H} (VI)

wherein:

A=R¹R²R³Si—;

B^{H}=—Si(R⁵)(R^{6H})—;

C^{H}=R⁷R⁸R^{9H}Si—;

subscripts a, b, c, d and e are 0 or 1 and subject to the following relationships: a+b=1 and when e=1, c+d=1;

R¹, R², R³, R⁵, R⁷, R⁸ are independently selected from the group consisting of monovalent hydrocarbon groups containing from 1 to 8 carbon atoms, more specifically from 1 to 4 carbon atoms, and monovalent aryl and alkaryl hydrocarbon groups containing from 6 to 12 carbon atoms, or R¹⁰,

wherein R¹⁰ is selected from a group consisting of branched monovalent hydrocarbon groups of containing from 3 to 6 carbon atoms, such as the non-limiting examples of isopropyl, t-butyl and t-amyl;

R⁴ and R¹¹ are independently selected from the group consisting of a divalent hydrocarbon group containing from 1 to 4 carbon atoms, more specifically from 1 to 3 carbon atoms;

R^{6H} and R^{9H} are selected from the group consisting of linear or branched monovalent hydrocarbon groups containing from 1 to 8 carbon atoms, more specifically from 1 to 4 carbon atoms, or hydrogen, provided R^{6H} and R^{9H} are different and R^{6H} or R^{9H} is hydrogen, and

wherein the olefinically-modified intermediate possesses one or more oxirane or oxetane groups and contains one or more terminal or pendant carbon-carbon double bonds and contains from 3 to 12 carbon atoms, more specifically from 3 to 6 carbon atoms,

to produce an epoxy-modified organosilicon intermediate; and,

(b) adding the epoxy-modified organosilicon intermediate to a quaternary alkyl dimethyl tertiary amine cation; wherein the quaternary alkyl dimethyl tertiary amine cation is made in-situ to produce the quaternary organosilicon having the general formula (I).

In one embodiment herein, precious metal catalysts suitable for making epoxy-substituted organosilicon intermediates are also well known in the art and comprise complexes of rhodium, ruthenium, palladium, osmium, iridium, or platinum. Many types of platinum catalysts for Si—H olefin addition reactions are known, and such platinum catalysts may be used to generate any of the compositions described herein. The platinum compound can be selected from those having the formula (PtCl₂Olefin) and H(PtCl₃Olefin) as described in U.S. Pat. No. 3,159,601, hereby incorporated by reference. A further platinum containing material can be a complex of chloroplatinic acid with up to 2 moles per gram of platinum of a member selected from the class consisting of alcohols, ethers, aldehydes and mixtures thereof as described in U.S. Pat. No. 3,220,972 hereby incorporated by reference. Yet another group of platinum containing materials useful in this present invention is described in U.S. Pat. Nos. 3,715,334; 3,775,452 and 3,814,730 (Karstedt). Those skilled in the art can easily determine an effective amount of platinum catalyst. Generally an effective amount ranges from about 0.1 to 50 parts per million of the total epoxy modified organosilicon intermediate.

Another method of making the quaternary organosilicon having the general formula (I) comprises:

(a) reacting a hydride intermediate with an olefinically-modified intermediate in the range of from 1:1 to 1:1.4 mole ratio of hydride intermediate to olefinically modified intermediate in the presence of a catalyst, such as a hydrosilylation catalyst, such as the non-limiting examples of precious metal catalysts such as those described herein; and wherein the olefinically-modified intermediate is a molecule containing one or more oxirane or oxetane groups and containing one or more terminal or pendant carbon-carbon bonds, and containing from 4-12 carbon atoms, such as the non-limiting examples of allyl oxiranes, olefinically modified epoxides, such as those of the general formula: CH₂=CH—(CH₂)_{y}O(CH₂)_{z}CH(O)CH₂, where subscripts y and z are from 1 to 10, or

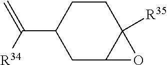

wherein R³⁴ and R³⁵ are independently selected from the group consisting of a monovalent hydrocarbon group containing from 1 to 2 carbon atoms, and where one non-limiting example of olefinically-modified intermediate is allyl glycidyl ether and where, in one embodiment, the hydride intermediate has the general formula (VI):

AOₐR⁴_{b}(B^{H}O_{c}R¹¹_{d})ₑC^{H} (VI)

wherein:

A=R¹R²R³Si—;

B^{H}=—Si(R⁵)(R^{6H})—;

C^{H}=R⁷R⁸R^{9H}si—;

subscripts a, b, c, d and e are 0 or 1 and subject to the following relationships: a+b=1 and when e=1, c+d=1;

R¹, R², R³, R⁵, R⁷, R⁸ are independently selected from the group consisting of monovalent hydrocarbon groups containing from 1 to 8 carbon atoms, more specifically from 1 to 6 carbon atoms, and monovalent aryl and alkaryl hydrocarbon groups containing from 6 to 12 carbon atoms, or R¹⁰,

wherein R¹⁰ is selected from a group consisting of branched monovalent hydrocarbon groups of containing from 3 to 6 carbon atoms, such as the non-limiting examples of isopropyl, t-butyl and t-amyl;

R⁴ and R¹¹ are independently selected from the group consisting of a divalent hydrocarbon group containing from 1 to 4 carbon atoms, more specifically from 1 to 3 carbon atoms;

R^{6H} and R^{9H} are selected from the group consisting of linear or branched monovalent hydrocarbon groups containing from 1 to 8 carbon atoms, more specifically from 1 to 4 carbon atoms, or hydrogen, provided R^{6H} and R^{9H} are different and R^{6H} or R^{9H} is hydrogen, and

wherein the olefinically-modified intermediate possesses one or more oxirane or oxetane groups and contains one or more terminal or pendant carbon-carbon double bonds and contains from 4 to 12 carbon atoms, more specifically from 3 to 6 carbon atoms,

to produce an epoxy-modified organosilicon intermediate; and,

(b) reacting an alkyl dimethyl tertiary amine with an acid to produce a quaternary alkyl dimethyl amine intermediate

reacting the epoxy-modified organosilicon intermediate with an alkyl dimethyl tertiary amine to produce an amine-modified organosilicon intermediate; and,

(c) reacting the quaternary alkyl dimethyl amine intermediate with the epoxy-modified organosilicon intermediate to produce the quaternary organosilicon having the general formula (I).

Some applications in which the surfactant composition can be employed are agricultural applications, coating applications, personal care applications and home care applications, as well as textiles, laundry and oil and gas applications. In general the amount of the respective quaternary organosilicon having the general formula (I) that is used in each application will vary upon the desired application and properties thereof and can be adjusted as necessary by those skilled in the art.

The compositions of the present invention may be utilized in a variety of forms: as liquid solutions, dispersions of solids in liquids, dispersions of liquids in liquids as emulsions, solid mixtures or solid solutions either separately or in combination with the others.

The various uses/applications in which the surfactant composition of the present invention can be employed are as follow:

A. Pesticide—Agriculture, Horticulture, Turf, Ornamental and Forestry:

An agricultural composition is defined as a composition related to the use of fertilizers, insecticide, herbicide, fungicide, and plant growth regulators in crop, forestry, turf and ornamental, and rights-of-way applications.

Many pesticide applications require the addition of an adjuvant to the spray mixture to provide wetting and spreading on foliar surfaces. Often that adjuvant is a surfactant, which can perform a variety of functions, such as increasing spray droplet retention on difficult to wet leaf surfaces, enhance spreading to improve spray coverage, or to provide penetration of the herbicide into the plant cuticle. These adjuvants are provided either as a tank-side additive or used as a component in pesticide formulations.

Typical uses for pesticides include agricultural, horticultural, turf, ornamental, home and garden, veterinary and forestry applications. The pesticidal compositions of the present invention also include at least one pesticide, where the quaternary organosilicon based surfactant of the present invention is present at an amount sufficient to deliver between 0.005% and 2% to the final use concentration, either as a concentrate or diluted in a tank mix. Optionally the pesticidal composition may include excipients, cosurfactants, solvents, foam control agents, deposition aids, drift retardants, biologicals, micronutrients, fertilizers and the like. The term pesticide means any compound used to destroy pests, e.g., rodenticides, insecticides, miticides, fungicides, and herbicides. Illustrative examples of pesticides that can be employed include, but are not limited to, growth regulators, photosynthesis inhibitors, pigment inhibitors, mitotic disrupters, lipid biosynthesis inhibitors, cell wall inhibitors, and cell membrane disrupters. The amount of pesticide employed in compositions of the invention varies with the type of pesticide employed.

More specific examples of pesticide compounds that can be used with the compositions of the invention are, but not limited to, herbicides and growth regulators, such as: phenoxy acetic acids, phenoxy propionic acids, phenoxy butyric acids, benzoic acids, triazines and s-triazines, substituted ureas, uracils, bentazon, desmedipham, methazole, phenmedipham, pyridate, amitrole, clomazone, fluridone, norflurazone, dinitroanilines, isopropalin, oryzalin, pendimethalin, prodiamine, trifluralin, glyphosate, sulfonylureas, imidazolinones, clethodim, diclofop-methyl, fenoxaprop-ethyl, fluazifop-p-butyl, haloxyfop-methyl, quizalofop, sethoxydim, dichlobenil, isoxaben, and bipyridylium compounds. Additionally, dicamba and tembotrione.

Fungicide compositions that can be used with the present invention include, but are not limited to, aldimorph, tridemorph, dodemorph, dimethomorph; flusilazol, azaconazole, cyproconazole, epoxiconazole, furconazole, propiconazole, tebuconazole and the like; imazalil, thiophanate, benomyl carbendazim, chlorothialonil, dicloran, trifloxystrobin, fluoxystrobin, dimoxystrobin, azoxystrobin, furcaranil, prochloraz, flusulfamide, famoxadone, captan, maneb, mancozeb, dodicin, dodine, and metalaxyl.

Insecticides, including larvacide, miticide and ovacide compounds that can be used with the composition of the present invention, but not limited to, Bacillus thuringiensis, spinosad, abamectin, doramectin, lepimectin, pyrethrins, carbaryl, primicarb, aldicarb, methomyl, amitraz, boric acid, chlordimeform, novaluron, bistrifluron, triflumuron, diflubenzuron, imidacloprid, diazinon, acephate, endosulfan, kelevan, dimethoate, azinphos-ethyl, azinphos-methyl, izoxathion, chlorpyrifos, clofentezine, lambda-cyhalothrin, permethrin, bifenthrin, cypermethrin and the like.

Fertilizers and Micronutrients:

Fertilizers or micronutrients include, but not limited to, zinc sulfate, ferrous sulfate, ammonium sulfate, urea, urea ammonium nitrogen, ammonium thiosulfate, potassium sulfate, monoammonium phosphate, urea phosphate, calcium nitrate, boric acid, potassium and sodium salts of boric acid, phosphoric acid, magnesium hydroxide, manganese carbonate, calcium polysulfide, copper sulfate, manganese sulfate, iron sulfate, calcium sulfate, sodium molybdate, calcium chloride.

The pesticide or fertilizer may be a liquid or a solid. If a solid, it is preferable that it is soluble in a solvent, or the quaternary organosilicon based surfactants of the present invention, prior to application, and the silicone may act as a solvent, or surfactant for such solubility or additional surfactants may perform this function.

Agricultural Excipients:

Buffers, preservatives and other standard excipients known in the art also may be included in the composition.

Solvents may also be included in compositions of the present invention. These solvents are in a liquid state at room temperature. Examples include water, alcohols, aromatic solvents, oils (i.e. mineral oil, vegetable oil, silicone oil, and so forth), lower alkyl esters of vegetable oils, fatty acids, ketones, glycols, polyethylene glycols, diols, paraffinics, and so forth. Particular solvents would be 2, 2, 4 trimethyl, 1 3 pentane diol and alkoxylated (especially ethoxylated) versions thereof as illustrated in U.S. Pat. No. 5,674,832 herein incorporated by reference, or n-methyl-pyrrilidone.

Cosurfactants:

Cosurfactants useful herein include nonionic, cationic, anionic, amphoteric, zwitterionic, polymeric surfactants, or any mixture thereof. Surfactants are typically hydrocarbon based, silicone based or fluorocarbon based.

Moreover, other cosurfactants, that have short chain hydrophobes that do not interfere with superspreading as described in U.S. Pat. No. 5,558,806 herein incorporated by reference are also useful.

Useful surfactants include alkoxylates, especially ethoxylates, containing block copolymers including copolymers of ethylene oxide, propylene oxide, butylene oxide, and mixtures thereof; alkylarylalkoxylates, especially ethoxylates or propoxylates and their derivatives including alkyl phenol ethoxylate; arylarylalkoxylates, especially ethoxylates or propoxylates. and their derivatives; amine alkoxylates, especially amine ethoxylates; fatty acid alkoxylates; fatty alcohol alkoxylates; alkyl sulfonates; alkyl benzene and alkyl naphthalene sulfonates; sulfated fatty alcohols, amines or acid amides; acid esters of sodium isethionate; esters of sodium sulfosuccinate; sulfated or sulfonated fatty acid esters; petroleum sulfonates; N-acyl sarcosinates; alkyl polyglycosides; alkyl ethoxylated amines; and so forth.

Specific examples include alkyl acetylenic diols (SURFONYL—Air Products), pyrrilodone based surfactants (e.g., SURFADONE—LP 100—Ashland), 2-ethyl hexyl sulfate, isodecyl alcohol ethoxylates (e.g., RHODASURF DA 530—Rhodia), ethylene diamine alkoxylates (TETRONICS—BASF), ethylene oxide/propylene oxide copolymers (PLURONICS—BASF), Gemini type surfactants (Rhodia) and diphenyl ether Gemini type surfactants (e.g. DOWFAX—Dow Chemical).

Preferred surfactants include ethylene oxide/propylene oxide copolymers (EO/PO); amine ethoxylates; alkyl polyglycosides; oxo-tridecyl alcohol ethoxylates, and so forth.

In a preferred embodiment, the agrochemical composition of the present invention further comprises one or more agrochemical ingredients. Suitable agrochemical ingredients include, but not limited to, herbicides, insecticides, growth regulators, fungicides, miticides, acaricides, fertilizers, biologicals, plant nutritionals, micronutrients, biocides, paraffinic mineral oil, methylated seed oils (i.e. methylsoyate or methylcanolate), vegetable oils (such as soybean oil and canola oil), water conditioning agents such as Choice® (Loveland Industries, Greeley, Colo.) and Quest® (Helena Chemical, Collierville, Tenn.), modified clays such as Surround® (BASF), foam control agents, surfactants, wetting agents, dispersants, emulsifiers, deposition aids, antidrift components, and water.

Suitable agrochemical compositions are made by combining, in a manner known in the art, such as, by mixing one or more of the above components with the quaternary organosilicon based surfactant of the present invention, either as a tank-mix, or as an “In-can” formulation. The term “tank-mix” means the addition of at least one agrochemical to a spray medium, such as water or oil, at the point of use. The term “In-can” refers to a formulation or concentrate containing at least one agrochemical component. The “In-can” formulation may then diluted to use concentration at the point of use, typically in a Tank-mix, or it may be used undiluted.

B. Coatings:

Typically coatings formulations will require a wetting agent or surfactant for the purpose of emulsification, compatibilization of components, leveling, flow and reduction of surface defects. Additionally, these additives may provide improvements in the cured or dry film, such as improved abrasion resistance, antiblocking, hydrophilic, and hydrophobic properties. Coatings formulations may exists as, Solvent-borne coatings, water-borne coatings and powder coatings.

The coatings components may be employed as: architecture coatings; OEM product coatings such as automotive coatings and coil coatings; special purpose coatings such as industrial maintenance coatings and marine coatings;

Typical resin types include: Polyesters, alkyds, acrylics, epoxies and polyurethanes.

C. Personal Care

In a preferred embodiment, the quaternary organosilicon based surfactant of the present invention comprises, per 100 parts by weight (“pbw”) of the personal care composition, from 0.1 to 99 pbw, more preferably from 0.5 pbw to 30 pbw and still more preferably from 1 to 15 pbw of the quaternary organosilicon based surfactant and from 1 pbw to 99.9 pbw, more preferably from 70 pbw to 99.5 pbw, and still more preferably from 85 pbw to 99 pbw of the personal care composition.

The quaternary organosilicon based surfactant compositions of the present invention may be utilized in personal care emulsions, such as lotions, and creams. As is generally known, emulsions comprise at least two immiscible phases one of which is continuous and the other which is discontinuous. Further emulsions may be liquids with varying viscosities or solids. Additionally the particle size of the emulsions may render them microemulsions and, when sufficiently small, microemulsions may be transparent. Further it is also possible to prepare emulsions of emulsions and these are generally known as multiple emulsions. These emulsions may be:

1) aqueous emulsions where the discontinuous phase comprises water and the continuous phase comprises the quaternary organosilicon based surfactant of the present invention;

2) aqueous emulsions where the discontinuous phase comprises the quaternary organosilicon based surfactant of the present invention and the continuous phase comprises water;

3) non-aqueous emulsions where the discontinuous phase comprises a non-aqueous hydroxylic solvent and the continuous phase comprises the quaternary organosilicon based surfactant of the present invention; and

4) non-aqueous emulsions where the continuous phase comprises a non-aqueous hydroxylic organic solvent and the discontinuous phase comprises the quaternary organosilicon based surfactant of the present invention.

Non-aqueous emulsions comprising a silicone phase are described in U.S. Pat. No. 6,060,546 and U.S. Pat. No. 6,271,295 the disclosures of which are herewith and hereby specifically incorporated by reference.

As used herein the term “non-aqueous hydroxylic organic compound” means hydroxyl containing organic compounds exemplified by alcohols, glycols, polyhydric alcohols and polymeric glycols and mixtures thereof that are liquid at room temperature, e.g. about 25° C., and about one atmosphere pressure. The non-aqueous organic hydroxylic solvents are selected from the group consisting of hydroxyl containing organic compounds comprising alcohols, glycols, polyhydric alcohols and polymeric glycols and mixtures thereof that are liquid at room temperature, e.g. about 25° C., and about one atmosphere pressure. Preferably the non-aqueous hydroxylic organic solvent is selected from the group consisting of ethylene glycol, ethanol, propyl alcohol, iso-propyl alcohol, propylene glycol, dipropylene glycol, tripropylene glycol, butylene glycol, iso-butylene glycol, methyl propane diol, glycerin, sorbitol, polyethylene glycol, polypropylene glycol mono alkyl ethers, polyoxyalkylene copolymers and mixtures thereof.

Once the desired form is attained whether as a silicone only phase, an anhydrous mixture comprising the silicone phase, a hydrous mixture comprising the silicone phase, a water-in-oil emulsion, an oil-in-water emulsion, or either of the two non-aqueous emulsions or variations thereon, the resulting material is usually a cream or lotion with improved deposition properties and good feel characteristics. It is capable of being blended into formulations for hair care, skin care, antiperspirants, sunscreens, cosmetics, color cosmetics, insect repellants, vitamin and hormone carriers, fragrance carriers and the like.

The personal care applications where the quaternary organosilicon based surfactant of the present invention and the silicone compositions derived therefrom of the present invention may be employed include, but are not limited to, deodorants, antiperspirants, antiperspirant/deodorants, shaving products, skin lotions, moisturizers, toners, bath products, cleansing products, hair care products such as shampoos, conditioners, mousses, styling gels, hair sprays, hair dyes, hair color products, hair bleaches, waving products, hair straighteners, manicure products such as nail polish, nail polish remover, nails creams and lotions, cuticle softeners, protective creams such as sunscreen, insect repellent and anti-aging products, color cosmetics such as lipsticks, foundations, face powders, eye liners, eye shadows, blushes, makeup, mascaras and other personal care formulations where silicone components have been conventionally added, as well as drug delivery systems for topical application of medicinal compositions that are to be applied to the skin.

In a preferred embodiment, the personal care composition of the present invention further comprises one or more personal care ingredients. Suitable personal care ingredients include, for example, emollients, moisturizers, humectants, pigments, including pearlescent pigments such as, for example, bismuth oxychloride and titanium dioxide coated mica, colorants, fragrances, biocides, preservatives, antioxidants, anti-microbial agents, anti-fungal agents, antiperspirant agents, exfoliants, hormones, enzymes, medicinal compounds, vitamins, salts, electrolytes, alcohols, polyols, absorbing agents for ultraviolet radiation, botanical extracts, surfactants, silicone oils, volatile silicones, organic oils, waxes, film formers, thickening agents such as, for example, fumed silica or hydrated silica, particulate fillers, such as for example, talc, kaolin, starch, modified starch, mica, nylon, clays, such as, for example, bentonite and organo-modified clays.

Suitable personal care compositions are made by combining, in a manner known in the art, such as, for example, by mixing, one or more of the above components with the quaternary organosilicon based surfactant. Suitable personal care compositions may be in the form of a single phase or in the form of an emulsion, including oil-in-water, water-in-oil and anhydrous emulsions where the silicone phase may be either the discontinuous phase or the continuous phase, as well as multiple emulsions, such as, for example, oil-in water-in-oil emulsions and water-in-oil-in water-emulsions.

In one useful embodiment, an antiperspirant composition comprises the quaternary organosilicon based surfactant of the present invention and one or more active antiperspirant agents. Suitable antiperspirant agents include, for example, the Category I active antiperspirant ingredients listed in the U.S. Food and Drug Administration's Oct. 10, 1993 Monograph on antiperspirant drug products for over-the-counter human use, such as, for example, aluminum halides, aluminum hydroxyhalides, for example, aluminum chlorohydrate, and complexes or mixtures thereof with zirconyl oxyhalides and zirconyl hydroxyhalides, such as for example, aluminum-zirconium chlorohydrate, aluminum zirconium glycine complexes, such as, for example, aluminum zirconium tetrachlorohydrex gly.

In another useful embodiment, a skin care composition comprises the quaternary organosilicon based surfactant, and a vehicle, such as, for example, a silicone oil or an organic oil. The skin care composition may, optionally, further include emollients, such as, for example, triglyceride esters, wax esters, alkyl or alkenyl esters of fatty acids or polyhydric alcohol esters and one or more the known components conventionally used in skin care compositions, such as, for example, pigments, vitamins, such as, for example, Vitamin A, Vitamin C and Vitamin E, sunscreen or sunblock compounds, such as, for example, titanium dioxide, zinc oxide, oxybenzone, octylmethoxy cinnamate, butylmethoxy dibenzoylm ethane, p-aminobenzoic acid and octyl dimethyl-p-aminobenzoic acid.

In another useful embodiment, a color cosmetic composition, such as, for example, a lipstick, a makeup or a mascara composition comprises the quaternary organosilicon based surfactant, and a coloring agent, such as a pigment, a water soluble dye or a liposoluble dye.

In another useful embodiment, the compositions of the present invention are utilized in conjunction with fragrant materials. These fragrant materials may be fragrant compounds, encapsulated fragrant compounds, or fragrance releasing compounds that either the neat compounds or are encapsulated. Particularly compatible with the compositions of the present invention are the fragrance releasing silicon containing compounds as disclosed in U.S. Pat. Nos. 6,046,156; 6,054,547; 6,075,111; 6,077,923; 6,083,901; and 6,153,578; all of which are herein and herewith specifically incorporated by reference.

The uses of the compositions of the present invention are not restricted to personal care compositions, other products such as waxes, polishes and textiles treated with the compositions of the present invention are also contemplated.

D. Home Care

Home care applications include laundry detergent and fabric softener, dishwashing liquids, wood and furniture polish, floor polish, tub and tile cleaners, toilet bowl cleaners, hard surface cleaners, window cleaners, antifog agents, drain cleaners, auto-dish washing detergents and sheeting agents, carpet cleaners, prewash spotters, rust cleaners and scale removers.

In one other embodiment herein the quaternary organosilicon surfactant composition of the present invention is such that the foliar uptake of various agricultural chemicals is faster for applications containing the quaternary organosilicon having the general formula (I) than that for equivalent applications containing a tallow amine ethoxylate. In one more specific embodiment, the foliar uptake of ¹⁴C-Glyphosate-IPA into barnyardgrass (Echinachloa crus-galii) was determined by the method described in the attached Gaskin et al. reference at 2 hours after treatment (HAT), and was shown to be 8.9 times greater than Tallow Amine Ethoxylate.

The following nonrestrictive examples are further illustrative of the invention.

### Examples

### Preparation Example 1

### Synthesis of Quaternary Carbosilanes (QC-1/QC-1A)

15 g (0.0546 mol) of mono epoxy functional carbosilane (Structure 1) 7.478 g (0.0546 mol) of dimethylol propionic acid, 5.63-6 g (0.0546 mol) of N, N′-dimethylamino propanol and 26.7 g of isopropanol were charged into a 3-neck flask attached with a condenser, under nitrogen. This mixture was quickly heated at 80-82° C. and stirred for 18 h. The flask was cooled to room temperature and isopropanol was removed at 40-45° C. under vacuum for 4 h. Finally the sample was dried into an oven at 50° C. for 3 days to obtain a light yellow viscous gel.

NMR confirmed that the quaternary ammonium salt as shown in structure 2 (FIG. 3) was formed. This gave 90% conversion to the quat by LC-MS (Product ID: QC-1). A subsequent prep of the same starting materials gave a conversion of 75% (Product ID: QC-1A).

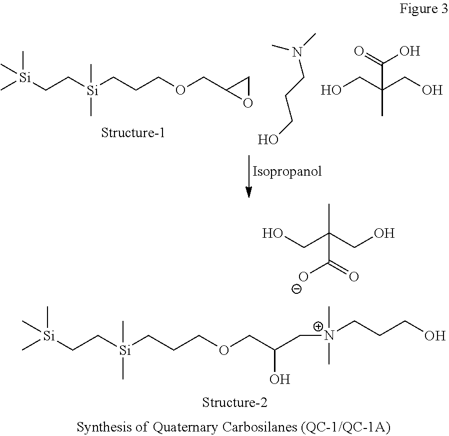

### Preparation Example 2

### Synthesis of Quaternary Carbosilane (QC-2)

14.25 g (0.0519 mol) of mono epoxy functional carbosilane (structure
1) 7.10 g (0.0519 mol) of dimethylol propionic acid, 6.185 g (0.0519 mol) of N, N′-dimethylamino propane 1,2-diol and 27.5 g of isopropanol were charged into a 3-neck flask attached with a condenser, under nitrogen. This mixture was quickly heated at 80-82° C. and stirred for 18 h. The flask was cooled to room temperature and isopropanol was removed at 40-45° C. under vacuum for 4 h. Finally the sample was dried into an oven at 50° C. for 3 days to obtain a very light yellow viscous gel. MS confirmed that the quaternary ammonium salt as shown in Structure 3 (FIG. 4) was formed with 80% conversion (Product ID: QC-2).

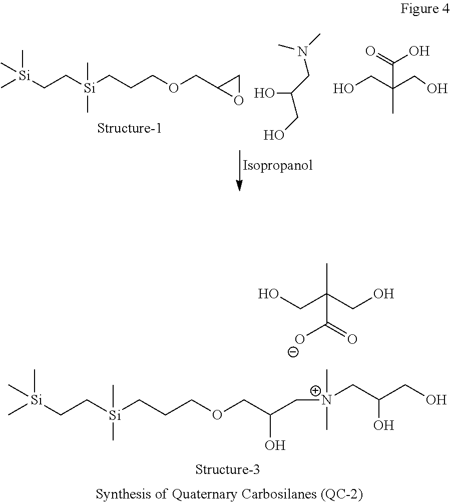

### Preparation Example 3

### Synthesis of Quaternary Carbosilane (QC-3)

14.25 g (0.0519 mol) of mono epoxy functional carbosilane (structure 1) 7.10 g (0.0519 mol) of dimethylol propionic acid, 5.259 g (0.0519 mol) of N, N′-dimethybutyl amine were charged into a 3-neck flask attached with a condenser, under nitrogen. This mixture was quickly heated at 87-90° C. and stirred for 18 h. The flask was cooled to room temperature. Finally the sample was dried into an oven at 50° C. for 3 days to obtain a deep brown viscous gel.

NMR confirmed that the quaternary ammonium salt as shown in Structure 4 (FIG. 5) was formed (Product ID: QC-3).

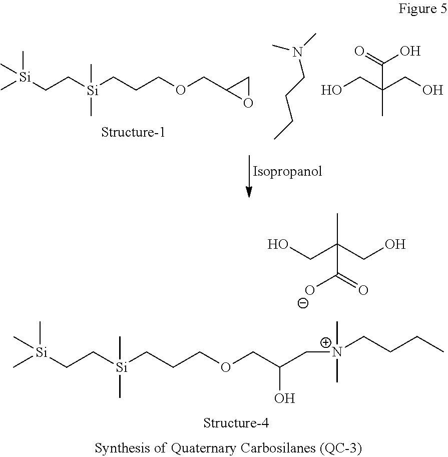

### Preparation Example 4

### Synthesis of Quaternary Trisiloxane (TSQ-1)

15 g (0.0445 mol) of 2-(3-glycidyloxypropyl)-heptamethyltrisiloxane (Structure 5) 6.097 g (0.0445 mol) of dimethylol propionic acid, 4.596 g (0.0445 mol) of N, N′-dimethylamino propanol and 12 g of isopropanol were charged into a 3-neck flask attached with a condenser, under nitrogen. This mixture was quickly heated at 60-65° C. and stirred for 18 h. The flask was cooled to room temperature and isopropanol was removed at 25° C. under vacuum for 2 h to obtain a yellow viscous gel.

MS confirmed that the quaternary ammonium salt as shown in Structure 6 (FIG. 6) was formed. (Product ID: TSQ-1).

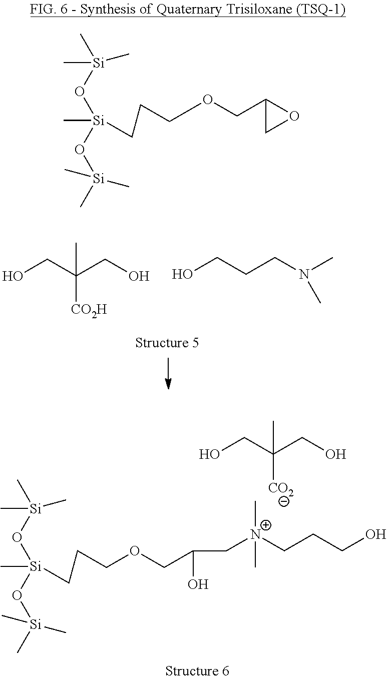

### Comparative Organosilicon Surfactants

Comparative organosilicon surfactants are described below:

Comparative-A: (CH₃)₃—Si—CH₂CH₂Si(CH₃)₂CH₂CH₂CH₂O(CH₂CH₂O)₈CH₃
Comparative-B: Trisiloxane Ethoxylate (Silwet L-77): (CH₃)₃—Si—O—Si(CH₃)(Z)—OS i(CH₃)₃
Where Z=—CH₂CH₂CH₂O(CH₂CH₂O)₈CH₃

Other Surfactants:

Other Comparative Non-Silicon based surfactants are described in Table 1.

TABLE 1
Non-Silicon Based Surfactants

| Surfactant | ID | Source | Description |
|---|---|---|---|
| Ethomeen T/25 | TAE-1 | Akzo Nobel | Tallow Amine Ethoxylate; |
| | | | 15 EO units |
| Adsee 4130 | TAE-2 | Akzo Nobel | Blend of Tallow Amine |
| | | | Ethoxylate and glycol ethers |
| Agrimul 2067 | APG | Cognis | Alkylpolyglycoside; C₈₋₁₀ with |
| | | | ~1.7 glycoside units |
| Ag-Rho FKC 1000 | AMPH | Rhodia | Amphoteric |

Spreading Properties of Quaternary Organosilicons

Spreading was determined using between 0.1% and 0.4% (actives) surfactant. Solutions were prepared in Milli-Pore water (deionized) where a 10 μl, drop was placed on a polystyrene surface (Petri-dish) and the spread diameter determined after 30 seconds.

TABLE 2
Spread Properties of Quaternary Carbosilanes

| Surfactant ID | 0.1 wt % | 0.2 wt % | 0.4 wt % |
|---|---|---|---|
| QC-1 | 13 | 33 | 47 |
| QC-2 | 10 | 23 | 40 |
| QC-3 | 14 | 23 | 36 |
| TSQ-1 | 15 | 30 | nd |
| TAE-2 | 5 | 6 | 7 |
| Comparative-A | 43 | 54 | nd |

The Comparative-A sample gave the highest degree of spreading. However, the compositions of the present invention gave an unexpected increase in spreading relative to the non-silicon based cationic surfactant TAE-2. Typically one skilled in the art would expect spreading of quaternary organosilicon surfactants to give a level of spreading similar to TAE-2 (Table 2).

Surface Properties of Quaternary Trisiloxane

This test demonstrates the surface tension efficiency of the composition of the present invention. The aqueous surface tension of the various surfactants was determined by the Wilhelmy Plate method using a sand-blasted platinum blade as the sensor. Measurements were made using a Kruss surface Tensiometer. Surfactant solutions were prepared between 0.00001% and 1 wt % in 0.005M NaCl at ambient temperatures (˜22° C.).

Table 3 demonstrates the TSQ-1 unexpectedly provides a surface tension similar to the nonionic counterpart trisiloxane ethoxylate (Comparative-B), and a lower surface tension than carbosilane ethoxylate (Comparative-A), at concentrations between 0.01 and 1 wt % (Typical use levels for agricultural spray applications).

TABLE 3
Surface Properties of Quaternary Trisiloxane

| Weight % | Surface Tension (mN/m) | | |
|---|---|---|---|
| Surfactant | Comparative-A | Comparative-B | TSQ-1 |
| 1.00E−05 | 62.4 | 52.9 | 66.7 |
| 1.00E−04 | 48.7 | 45.1 | 55.6 |
| 1.00E−03 | 34.8 | 34.2 | 38.3 |
| 3.00E−03 | 30.1 | 27.0 | 28.7 |
| 1.00E−02 | 25.4 | 21.5 | 22.3 |
| 1.00E−01 | 24.4 | 20.7 | 20.2 |
| 1.00E+00 | 23.7 | 20.6 | 19.9 |
| CMC^{1.} (Wt %) | 0.005 wt % | 0.01 wt % | 0.009 wt % |

Impact of Cosurfactant on Spread Properties

The use of a cosurfactant is often employed to confer additional benefits to a herbicide formulation. Either to act as a compatibility agent or to interact with a primary surfactant to develop the desired wetting properties. Common cosurfactants for glyphosate formulations are selected from tallowamine ethoxylates (TAE) containing 10-20 ethylaenoxide units, an alkylpolyglycoside (APG) derived from a fatty alcohol of 8 to 16 carbon units and containing between 1.2 to 1.7 glucose units, and amphoteric surfactants such as alkyl amido betaines.

Spreading was determined using 0.2% (actives) total surfactant solutions, where a 104 drop was placed on a polystyrene surface and the spread diameter determined after 30 seconds. The ratio of QC-1A to Cosurfactant was varied to determine the potential for synergistic or antagonistic effects from interaction between the two surfactants. The spread results (Actual) for each set were compared to a predicted value (weighted average) based on a linear relationship between QC-1A and the Cosurfactant.

Table 4 demonstrates that cosurfactants can have an impact on the spreading properties of the composition of the present invention. As expected, blends of QC-1A with TAE-1 were antagonistic toward the spreading of the QC-1A. This is observed as a decrease in spreading relative to the predicted value. However, surprisingly mixtures of QC-1A with APG gave an increase in spreading relative to the predicted value indicating a synergy in spreading. The QC-1A/Amphoteric blends gave a linear response at blend ratios containing at least 50% QC-1A. However, at blend rations of <50% QC-1A there appears to a non-linear response (slight antagonism) for spreading.

TABLE 4
Impact of Cosurfactants on Spreading of Quaternary Organosilicon

| | | Cosurfactant/Spread Diameter (mm) | | | | | |
|---|---|---|---|---|---|---|---|
| Wt % | | | TAE-1 | | APG | | AMPH |
| QC- | Wt % | TAE-1 | (Pre- | APG | (Pre- | AMPH | (Pre- |
| 1A | CoSurf. | (Actual) | dicted) | (Actual) | dicted) | (Actual) | dicted) |
| 0.2 | 0 | 48 | 48 | 48 | 48 | 48 | 48 |
| 0.15 | 0.05 | 9 | 37 | 48 | 39 | 40 | 39 |
| 0.1 | 0.1 | 8 | 27 | 42 | 29 | 27 | 29 |
| 0.05 | 0.15 | 7 | 16 | 37 | 20 | 12 | 20 |
| 0 | 0.2 | 5 | 5 | 10 | 10 | 10 | 10 |

Effect of Adjuvant on Uptake of ¹⁴C-Glyphosate Isopropylamine salt into Barnyardgrass.

Uptake of ¹⁴C-glyphosate (herbicide) into Barnyardgrass (Echinochloa crus-galli) was determined at 2 and 24 hours after treatment (HAT) according to the method described by Gaskin et al. (Gaskin, R. E.; Stevens, P. J. G. 1992. Pestic. Sci. 38: 185-192.), to establish the impact of surfactant on the speed of uptake. Uptake was determined on adaxial surface of youngest fully expanded leaf; plant at 4 leaf stage, ca 10 cm tall.

Table 5 demonstrates that the composition of the present invention QC-1 significantly enhances glyphosate uptake at 2 HAT relative to TAE-2, even at a 4× lower use rate (Compare TAE-2 at 0.2% vs QC-1 at 0.05%).

TABLE 5
Effect of surfactant on uptake of
¹⁴C-glyphosate into Barnyardgrass

| Adjuvant | Concn | Uptake % | |
|---|---|---|---|
| treatment | % w/v | 2 HAT | 24 HAT |
| QC-1 | 0.05 | 40.1 d | 57.6 be |
| QC-1 | 0.1 | 34.8 e | 56.2 c |
| QC-1 | 0.2 | 36.2 de | 61.6 b |
| TAE-2 | 0.2 | 4.5 f | 72.5 a |

Means sharing common postscripts are not significantly different (P_{0.05}, LSD test).

Dispersibility in Glyphosate

One important property for surfactants used in agricultural formulations is their dispersibility or solubility in high ionic strength solutions such as ammonium sulfate or herbicide salts (i.e, glyphosate isopropylamine).

Aqueous glyphosate-isopropyl amine (480 g/L) formulations containing 5% of either Comparative-B or the composition of the present invention were prepared and evaluated for dispersion properties. The formulations were visually observed for clarity at 20-22° C., and if clear to hazy, the cloud point was also measured.

Cloud point was determined by placing 15 mL of formulation in a 20 dram vial containing a digital thermometer, and slowly heating the mixture on a magnetic stirrer/hot plate. The temperature at which the solution became opaque was recorded as the cloud point.

Table 6 demonstrates that unlike Comparative-B, which is insoluble in the glyphosate formulation, the compositions of the present invention are either soluble or dispersible (hazy), allowing for use in high electrolyte formulations. Surfactant (Comparative-B) was insoluble in the glyphosate formulation.

TABLE 6
Cloud Point of surfactants at 5% in
glyphosate 480 g/L formulation

| Surfactant | Cloud Point ° C. (50 g/L) |
|---|---|
| QC-1 | >95° C. |
| QC-2 | >95° C. |
| QC-3 | Hazy at 20° C. |
| Comparative-B | Cloudy at 20° C.^{a.} |

### Preparation Example 5

Employing similar synthetic procedures as outlined in Preparation Examples 1-4 above, the following compound (Preparation Example 5) was prepared.

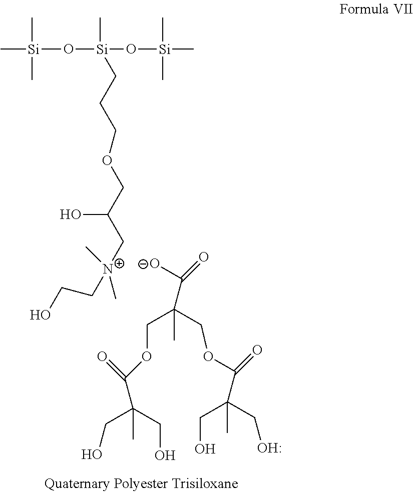

### Preparation Example 6

### Synthesis of Quaternary Carbosilane (QC-4)

3 g (0.011 mol) of mono epoxy functional carbosilane (structure 1) and 1.5 g (0.011 mol) of N, N′-dimethylamino propane 1,2-diol were charged into a 3-neck flask attached with a condenser, under nitrogen. This mixture was stirred at 25° C. for 2.5 h. To this mixture, 1.12 g (0.011 mol) of lactic acid and 2.5 ml of isopropanol were added and stirred for 18 h. The reaction was stopped at this stage and nitrogen was sparged through the reaction mixture. Finally, it was then kept at 25° C. under vacuum (3 torr) for 4 h to remove the volatiles. A reddish brown viscous liquid was obtained, and MS confirmed that the quaternary ammonium salt as shown in structure 7 was formed.

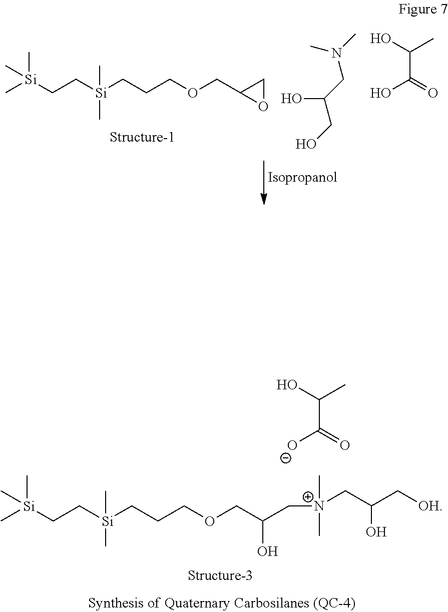

Biodegradability

In one embodiment herein the biodegradable surfactant composition of the present invention is such that the biodegradability of the polyester modified quaternary organosilicon having the general formula (I) is faster than the biodegradability of a trisiloxane alkoxylate, such as a polyakyleneoxide modified heptamethyl trisiloxane. In a more specific embodiment, the improvement is measured by standard 28 day Biochemical Oxygen Demand (BOD)/Chemical Oxygen Demand (COD) bioxidation tests. In one non-limiting example, such a BOD/COD test is the OECD TG 301° F. Ready Biodegradability: Manometric Respirometery Test. In one non-limiting embodiment the improvement of the biodegradable surfactant composition of the present invention (Formula VII) over that of a polyakyleneoxide modified heptamethyl trisiloxane is at least about 30% improvement relative to traditional trisiloxane alkoxylates such as Silwet L-77 surfactant.

While the invention has been described with reference to a number of exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to any particular exemplary embodiment disclosed herein.

What is claimed is:

1. A surfactant composition comprising a quaternary organosilicon salt having the general formula (I):
AOₐR⁴_{b}(BO_{c}R¹¹_{d})ₑC (I)
wherein:
A=R¹R²R³Si—;
B=—Si(R⁵)(R⁶)—;
C=R⁷R⁸R⁹Si—;
subscripts a, b, c, d and e are 0 or 1 and subject to the following relationships: a+b=1 and when e=1, c+d=1;
R¹, R², R³, R⁵, R⁷, R⁸ are each independently selected from the group consisting of monovalent hydrocarbon groups containing from 1 to 8 carbon atoms, monovalent aryl and alkaryl hydrocarbon groups containing from 6 to 12 carbon atoms, and R¹⁰,
where R¹⁰ is selected from the group consisting of branched monovalent hydrocarbon groups containing from 3 to 6 carbon atoms;
R⁴ and R¹¹ are each independently a divalent hydrocarbon group containing from 1 to 4 carbon atoms;
R⁶ and R⁹ are each independently selected from the group consisting of linear or branched monovalent hydrocarbon groups containing from 1 to 8 carbon atoms, and R¹², provided that R⁶ and R⁹ are different and one of R⁶ or R⁹ is R¹²,
wherein R¹² is selected from R* or —R¹³R¹⁴N^{⊕}(R¹⁵)(R¹⁶)R¹⁷X^{\grave{Y}},
wherein R* is 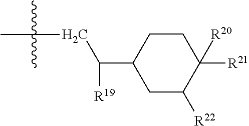
Wherein R¹⁹ and R²⁰ are independently selected from H or Methyl,
R²¹ and R²² are different, and selected from OH or R²³;
R²³ is —N^{⊕}(R¹⁵)(R¹⁶)R¹⁷X^{\grave{Y}},
wherein R¹³ is a divalent hydrocarbon group containing from 3 to 12 carbon atoms, and optionally substituted by one or more hydroxyl groups,
R¹⁴ is selected from the group consisting of —OCH₂CH(OH)CH₂— and an alkyleneoxide group of the general formula (II):
—[OC₂H₄]ₕ—[OC₃H₆]ᵢ—[OC₄H₈]ₖ—OCH₂CH(OH)CH₂— (II)
wherein subscripts h, i and k are zero or positive and satisfy the following relationships: 1≦h+i+k≦15, more specifically, 1≦h+i+k≦10, even more specifically h is from 0 to 8, i is from 0 to 5 and k is from 0 to 4,
R¹⁵ and R¹⁶ are independently selected from the group consisting of a monovalent hydrocarbon group containing from 1 to 2 carbon atoms,
R¹⁷ is selected from the group consisting of linear or branched hydrocarbon groups containing from 1 to 6 carbon atoms, which may each be optionally substituted with one or more hydroxyl groups, and an alkyleneoxide group of the general formula (III):
[OC₂H₄]ₘ—[OC₃H₆]ₙ−[OC₄H₈]ₚ—R¹⁸ (III)
wherein subscripts m, n and p are zero or positive and satisfy the following relationships: 1≦m+n+p≦15,
R¹⁸ is selected from the group consisting of —OH and monovalent hydrocarbon groups containing from 1 to 4 carbon atoms; and
X^{\grave{Y}} is R³⁴, or a more biodegradable group R^{PE},
R³⁴ is selected from the group consisting of carboxylic acid anion moiety containing from 2 to 22 carbon atoms, and has the general formula:
^{\grave{Y}}O—C(═O)—C(R³⁵)(R³⁶)(R³⁷)
wherein subscripts q, r and s are 0 or 1,
R³⁵ and R³⁶ are selected from H, OH, a hydrocarbon group of 1-3 carbon atoms or CH₂OH,
R³⁷ is selected from H, OH, a hydrocarbon group of 1-3 carbon atoms, CH₂OH or —(CH R³⁸)_{f}—CH₂R³⁹,
wherein R³⁸ is H, OH, a hydrocarbon group of 1-3 carbon atoms or CH₂OH; R³⁹ is H or OH,
subscript f is 0 to 3,
where R^{PE} is a polyester moiety derived from the esterification of the corresponding hydroxy carboxylic acid or a mixture of corresponding hydroxy carboxylic acids and carboxylic acids, wherein the hydroxy carboxylic acid(s) contain(s) from 2 to 8 carbon atoms, and R^{PE} is of the general formula (Z):
^{\grave{Y}}O—C(═O)—CH_{(3-[q+r+s])}(R²⁴)_{q}(R²⁵)ᵣ(R²⁶)ₛ (Z)
subscripts q, r and s are 0 or 1,
where R²⁴, R²⁵, R²⁶ are independently selected from —OH, —CH₂OH, —(CH₂)ₘOR²⁷, —CH₃, —CH₂CH₃, —(CH₂)ₘO—C(═O)(CR³⁰R³¹)ₜCH₂OR³², or R²⁸,
where R²⁷ is —C(═O)—CH_{(3-[q+r+s])}(R²⁴)_{q}(R²⁵)ᵣ(R²⁶)ₛ
R²⁸ is —R²⁹OR²⁷, where R²⁹ is a divalent hydrocarbon radical of 2 to 6 carbon atoms,
R³⁰ and R³¹ are independently selected from H, —OH, —CH₂OH, —(CH₂)ₘO—R²⁷, —CH₃, —CH₂CH₃, or —(CH₂)ₘO—C(═O)—(CR³⁰R³¹)ₜCH₂OR³²,
R³² is independently selected from H, —CH₂OH, —CH₃, —CH₂CH₃, R²⁷, or [—C(═O)(CR³⁰R³¹)ₜCH₂O]_{w}—R³³,
R³³ is independently selected from H, —CH₂OH, —CH₃, or —CH₂CH₃,
where,
subscript m is 0 to 3,
subscript t is 1 to 5,
subscript w is 1 to 5, and
the number of ester linkages in R^{PE} is between 1 and 10,
provided that when any one or more of R²⁴, R²⁵ and R²⁶ are of the formula —(CH₂)ₘO—C(═O)(CR₃₀R₃₁)ₜCH₂OR³² that R²⁴, R²⁵ and R²⁶ group contains from 1 to 10 —(CH₂)ₘO—C(═O)(CR³⁰R³¹)ₜCH₂OR³² groups.

2. The composition of claim 1 wherein X^{\grave{Y}} is selected from the group consisting of anions of monocarboxylic acids, dicarboxylic acids, alpha-hydroxyl acids, beta-hydroxyl acids, dihydroxy acids and saturated and unsaturated fatty acids.

3. The composition of claim 1 wherein the quaternary organosilicon has the general formula (IV):
AR⁴C (IV)
wherein:
A=R¹R²R³Si—; and
C=R⁷R⁸R⁹Si—;
wherein R′, R², R³, R⁷ and R⁸ are methyl;
R⁴ is —CH₂CH₂—;
R⁹ is R¹²,
wherein R¹² is —R¹³R¹⁴N^{⊕}(R¹⁵)(R¹⁶)R¹⁷X^{\grave{Y}},
wherein R¹³ is —CH₂CH₂CH₂—;
R¹⁴ is —OCH₂CH(OH)CH₂—;
R¹⁵ and R¹⁶ are methyl;
R¹⁷ is —CH₂CH(OH)CH₂—OH; and
X^{\grave{Y}} is CH₃C(CH₂OH)₂COO—.

4. The composition of claim 1 wherein the quaternary organosilicon has the general formula (V):
AR⁴BOC (V)
wherein:
A=R¹R²R³Si—;
B=—Si(R⁵)(R⁶)—; and
C=R⁷R⁸R⁹Si—;
wherein R¹, R², R³, R⁵, R⁶, R⁷ and R⁸ are methyl;
R⁹ is R¹²;
wherein R¹² is —R¹³R¹⁴N^{⊕}(R¹⁵)(R¹⁶)R¹⁷X^{\grave{Y}},
wherein R¹³ is —CH₂CH₂CH₂—;
R¹⁴ is —OCH₂CH(OH)CH₂—;
R¹⁵ and R¹⁶ are methyl;
R¹⁷ is —CH₂CH₂CH₂OH; and)
X^{\grave{Y}} is CH₃C(CH₂OH)₂COO—.

5. The composition of claim 1 wherein the quaternary organosilicon has the general formula (V-B):
AOBOC (V-B)
wherein:
A=R¹R²R³Si—;
B=—Si(R⁵)(R⁶)—; and
C=R⁷R⁸R⁹Si—;
wherein R¹, R², R³, R⁵, R⁷, R⁸ and R⁹ are methyl;
R⁶ is R¹²;
wherein R¹² is —R¹³R¹⁴N^{⊕}(R¹⁵)(R¹⁶)R¹⁷X^{\grave{Y}},
wherein R¹³ is —CH₂CH₂CH₂—;
R¹⁴ is —OCH₂CH(OH)CH₂—;
R¹⁵ and R¹⁶ are methyl;
R¹⁷ is —CH₂CH₂CH₂OH; and
X^{\grave{Y}} is CH₃C(CH₂OH)₂COO—.

6. A method of making quaternary organosilicon having the general formula (I) of claim 1 comprising:
(a) reacting a hydride intermediate with an olefinically-modified intermediate in the presence of a catalyst,
wherein:
the hydride intermediate has the general formula (VI):
AOₐR⁴_{b}(B^{H}O_{c}R¹¹_{d})ₑC^{H} (VI)
wherein:
A=R¹R²R³Si—;
B^{H}=—Si(R⁵)(R^{6H})—;
C^{H}=R⁷R⁸R^{9H}Si—;
subscripts a, b, c, d and e are 0 or 1 and subject to the following relationships: a+b=1 and c+d=1 (when e=1);
R¹, R², R³, R⁵, R⁷, R⁸ are independently selected from the group consisting of monovalent hydrocarbon groups containing from 1 to 8 carbon atoms, monovalent aryl and alkaryl hydrocarbon groups containing from 6 to 12 carbon atoms, and R¹⁰,
wherein R¹⁰ is selected from a group consisting of branched monovalent hydrocarbon groups of containing from 3 to 6 carbon atoms;
R⁴ and R¹¹ are independently selected from the group consisting of a divalent hydrocarbon group containing from 1 to 4 carbon atoms;
R^{6H} and R^{9H} are selected from the group consisting of linear or branched monovalent hydrocarbon groups containing from 1 to 8 carbon atoms, and hydrogen, provided R^{6H} and R^{9H} are different and R^{6H} or R^{9H} is hydrogen, and
the olefinically-modified intermediate possesses one or more oxirane or oxetane groups and contains one or more terminal or pendant carbon-carbon double bonds and contains from 4 to 12 carbon atoms,
to produce an epoxy-modified organosilicon intermediate; and,
(b) adding the epoxy-modified organosilicon intermediate to a quaternary alkyl dimethyl tertiary amine cation;
to produce the quaternary organosilicon having the general formula (I).

7. The method of claim 6 wherein the olefinically-modified intermediate is an allyl oxirane.

8. The method of claim 6 wherein the olefinically-modified intermediate is an allyl glycidyl ether.

9. The method of claim 6 wherein the quaternary alkyl dimethyl tertiary amine cation is formed in-situ.

10. A method of making quaternary organosilicon having the general formula (I) claim 1 comprising:
(a) reacting a hydride intermediate with an olefinically-modified intermediate in the presence of a catalyst,
wherein:
the hydride intermediate has the general formula (VI):
AOₐR⁴_{b}(B^{H}O_{c}R¹¹_{d})ₑC^{H} (VI)
wherein:
A=R¹R²R³Si—;
B^{H}—Si(R⁵)(R^{6H})—;
C^{H}=R⁷R⁸R^{9H}Si—;
subscripts a, b, c, d and e are 0 or 1 and subject to the following relationships: a+b=1 and when e=1, c+d=1;
R¹, R², R³, R⁵, R⁷, R⁸ are independently selected from the group consisting of monovalent hydrocarbon groups containing from 1 to 8 carbon atoms, monovalent aryl and alkaryl hydrocarbon groups containing from 6 to 12 carbon atoms, and R¹⁰,
wherein R¹⁰ is selected from a group consisting of branched monovalent hydrocarbon groups of containing from 3 to 6 carbon atoms;
R⁴ and R¹¹ are independently selected from the group consisting of a divalent hydrocarbon group containing from 1 to 4 carbon atoms;
R^{6H} and R^{9H} are selected from the group consisting of linear or branched monovalent hydrocarbon groups containing from 1 to 8 carbon atoms, and hydrogen, provided R^{6H} and R^{9H} are different and R^{6H} or R^{9H} is hydrogen, and
the olefinically-modified intermediate possesses one or more oxirane or oxetane groups and contains one or more terminal or pendant carbon-carbon double bonds and contains from 4 to 12 carbon atoms,
to produce an epoxy-modified organosilicon intermediate;
(b) reacting an alkyl dimethyl tertiary amine with an acid to produce the quaternary intermediate, which is added to the epoxy-modified organosilicon intermediate to produce the quaternary organosilicon having the general formula (I).

11. The method of claim 10 wherein the olefinically-modified intermediate is an allyl oxirane.

12. The method of claim 10 wherein the olefinically-modified intermediate is an allyl glycidyl ether.

13. An agricultural composition comprising (i) an agrochemical active ingredient; (ii) the surfactant composition of claim 1; (iii) optionally one or more agrochemical excipients selected from the group consisting of buffers, preservatives and solvents; and, (iv) optionally one or more cosurfactants selected from the group consisting of nonionic, cationic, anionic, amphoteric, zwitterionic and polymeric surfactants.

14. The agricultural composition of claim 13 wherein the composition is one or more of an herbicide, a fungicide and an insecticide.

15. The agricultural composition of claim 14 wherein the agrochemical ingredient is glyphosate.

16. A crop or plant having the agricultural composition of claim 13 applied thereto.

17. A coating composition comprising the surfactant composition of claim 1 wherein the coating application is selected from the group consisting of architecture coatings; OEM product coatings; industrial maintenance coatings and marine coatings.

18. A personal care composition comprising the surfactant composition of claim 1.

19. A personal care composition which is an aqueous emulsion where the discontinuous phase comprises water and the continuous phase comprises the surfactant composition of claim 1.

20. A personal care composition which is an aqueous emulsion where the discontinuous phase comprises the surfactant composition of claim 1 and the continuous phase comprises water.

21. A personal care composition which is a non-aqueous emulsion where the discontinuous phase comprises a non-aqueous hydroxylic solvent and the continuous phase comprises the surfactant composition of claim 1.

22. A personal care composition which is a non-aqueous emulsion where the continuous phase comprises a non-aqueous hydroxylic organic solvent and the discontinuous phase comprises the surfactant composition of claim 1.

23. A personal care application comprising the personal care composition of claim 18 wherein the personal care application is selected from the group consisting of deodorants, antiperspirants, antiperspirant/deodorants, shaving products, skin lotions, moisturizers, toners, bath products, cleansing products, hair care products such as shampoos, conditioners, mousses, styling gels, hair sprays, hair dyes, hair color products, hair bleaches, waving products, hair straighteners, manicure products such as nail polish, nail polish remover, nails creams and lotions, cuticle softeners, protective creams such as sunscreen, insect repellent and anti-aging products, color cosmetics such as lipsticks, foundations, face powders, eye liners, eye shadows, blushes, makeup, mascaras and other personal care formulations where silicone components have been conventionally added, as well as drug delivery systems for topical application of medicinal compositions that are to be applied to the skin.

24. The personal care application of claim 23 comprising at least one personal care ingredient selected from the group consisting of emollients, moisturizers, humectants, pigments, including pearlescent pigments such as, for example, bismuth oxychloride and titanium dioxide coated mica, colorants, fragrances, biocides, preservatives, antioxidants, anti-microbial agents, anti-fungal agents, antiperspirant agents, exfoliants, hormones, enzymes, medicinal compounds, vitamins, salts, electrolytes, alcohols, polyols, absorbing agents for ultraviolet radiation, botanical extracts, surfactants, silicone oils, volatile silicones, organic oils, waxes, film formers, thickening agents such as, for example, fumed silica or hydrated silica, particulate fillers, such as for example, talc, kaolin, starch, modified starch, mica, nylon, clays, such as, for example, bentonite and organo-modified clays.

25. A home care composition comprising the surfactant composition of claim 1.

26. A home care application comprising the home care composition of claim 25, wherein the home care application is selected from the group consisting of laundry detergent and fabric softener, dishwashing liquids, wood and furniture polish, floor polish, tub and tile cleaners, toilet bowl cleaners, hard surface cleaners, window cleaners, antifog agents, drain cleaners, auto-dish washing detergents and sheeting agents, carpet cleaners, prewash spotters, rust cleaners and scale removers.

27. The surfactant composition of claim 1 wherein the biodegradability of the ester-modified organosilicon having the general formula (I) is faster than the biodegradability of a trisiloxane alkoxylate.
